(19) United States
(12) Patent Application Publication
(10) Pub. No.: US 2024/0124222 A1
(43) Pub. Date: Apr. 18, 2024

(54) COLLECTION BIN FOR LASER CUTTER SCRAP

(71) Applicant: Connaughty Industries, Inc. dba Rushford Manufacturing, Rushford, MN (US)

(72) Inventors: Jay Thomas Hisel, Lansing, IA (US); Kenneth Gene Connaughty, Rushford, MN (US)

(73) Assignee: Connaughty Industries, Inc. dba Rushford Manufacturing, Rushford, MN (US)

(21) Appl. No.: 18/485,901

(22) Filed: Oct. 12, 2023

Related U.S. Application Data
(60) Provisional application No. 63/475,136, filed on Oct. 12, 2022.

(51) Int. Cl. B65F 1/12

(52) U.S. Cl. CPC B65F 1/125

(57) ABSTRACT

A collection bin for a laser cutting machine includes a first container and a second container. Each of the first and second containers include a base; opposite first and second sidewalls; an end wall; a first lift member; and a first pivot member. The first and second sidewalls extend from the base and between a first end and second end. The end wall extends from the base and between the first and second sidewalls at the second end. The first lift member is positioned between the first and second ends. The first lift member facilitates movement of the collection bin. An interior space is defined by the base, the first and second sidewalls, and the end wall. The first pivot member extends between the first and second containers and facilitates a transition between a containing state and an emptying state.

### CROSS-REFERENCE TO RELATED APPLICATION

This application claims the benefit of U.S. Provisional Application No. 63/475,136, filed Oct. 12, 2022, the disclosure of which is hereby incorporated by reference in its entirety.

### BACKGROUND

Laser cutters are advanced fabrication tools that employ a focused, high-powered laser beam to precisely cut, engrave, or etch materials. At a high level, these devices operate by directing the coherent light emitted from a laser tube onto a workpiece using a system of mirrors and lenses. Typically, a CNC system orchestrates the movement of the laser head, guiding it along a designated path according to a digital design file. Laser cutters are favored for their unparalleled accuracy, efficiency, and versatility, as they can process a wide range of materials including wood, plastics, textiles, metals, and more. Their non-contact cutting process minimizes material waste and reduces the risk of damage, making laser cutting an invaluable tool for industries such as manufacturing, architecture, and art.

Over time, waste material such as scrap, slag, slugs, etc., builds up below the laser cutter. Waste from the laser cutting process can include various metals and as a result, the waste buildup can be heavy. Regularly, the waste material needs to be removed from below the laser cutter. Some laser cutters include means, such as boxes or bins to collect the waste material. It is known to empty these bins manually which is difficult and time consuming. Therefore, it is desirable to improve the way waste material is collected and emptied.

### SUMMARY

In general terms, this disclosure is directed to a collection bin and method for laser cutter scrap. In some embodiments, and by non-limiting example, the collection bin for a laser cutting machine includes a first container and a second container. Each of the first and second containers includes a base; opposite first and second sidewalls; an end wall; a first lift member; and a first pivot member. The opposite first and second sidewalls extend from the base and between a first end and second end; the end wall extends from the base and between the first and second sidewalls at the second end. The first lift member is positioned between the first and second ends such that the lift member is nearer the first end than the second end. The first lift member is configured to facilitate movement of the collection bin. An interior space is defined by the base, the first and second sidewalls, and the end wall. The interior space is configured to hold material. The first pivot member extends between the first and second containers and is configured to facilitate a transition of the collection bin between a containing state and an emptying state. In certain examples, the first and second containers each further include a second lift member, where the first and second lift members are positioned on opposite first and second sides of the respective first and second containers. In certain examples, the collection bin further includes a second pivot member, where the second pivot member extends between the first and second containers and is configured to facilitate movement of the collection bin between a containing state and an emptying state, and where the first and second pivot members are positioned on opposite first and second sides of the collection bin. In certain examples, the first ends of the first and second containers are in contact and the bases of the first and second containers are in plane with each other when the collection bin is in the containing state. In certain examples, the first ends of the first and second containers are apart and the bases of the first and second containers are at an angle to each other when the collection bin is in the emptying state. In certain examples, the first lift member is at the first sidewall and the second lifting member is at the second sidewall. In certain examples, the first pivot member connects to the first sidewall of both the first and second containers at first and second locking member locations, and the second pivot member connects to the second sidewall of both the first and second containers at first and second locking member locations. In certain examples, the first sidewall includes a container aperture that is configured to engage the first pivot member, and where the second sidewall includes a container aperture that is configured to engage the second pivot member. In certain examples, the first and second sidewalls each include a relief at the first end to provide clearance for the first and second pivot members. In certain examples, the lift members are positioned nearer to the first end than to the second end of each of the first and second containers. In certain examples, the collection bin is configured to transition into the emptying state when a bottom side of the base of each first and second containers contacts first and second contact edges of a scrap bin respectively, where the first and second contact edges are nearer the second ends of the respective first and second containers than a center of mass of each of the first and second containers. In certain examples, the first and second lift member of each of the first and second containers are configured to connect to a lift assembly.

In one example, a collection bin system for a laser cutting machine includes a collection bin, a lift assembly, and first and second risers. The collection bin includes a first container and a second container. Each of the first and second containers includes a base; opposite first and second sidewalls; an end wall; a first lift member; and a first pivot member. The opposite first and second sidewalls extend from the base and between a first end and second end; the end wall extends from the base and between the first and second sidewalls at the second end. The first lift member is positioned between the first and second ends such that the lift member is nearer the first end than the second end. The first lift member is configured to facilitate movement of the collection bin. An interior space is defined by the base, the first and second sidewalls, and the end wall. The interior space is configured to hold material. The first pivot member extends between the first and second containers and is configured to facilitate a transition of the collection bin between a containing state and an emptying state. The lift assembly is removably attached to the first lift member and is configured to facilitate movement of the collection bin. The first and second risers are configured to be positioned at a material collection area and to provide clearance for the collection bin to transition from the containing state to the emptying state when the collection bin is positioned at first and second contact edges on the respective first and second risers. In certain examples, the first ends of the first and second containers are in contact and the bases of the first and second containers are in plane with each other when the collection bin is in the containing state. In certain examples, the first ends of the first and second containers are apart and the bases of the first and second containers are at an angle to each other when the collection bin is in the emptying state. In certain examples, the collection bin is configured to transition into the emptying state when a bottom side of the base of each first and second containers contacts first and second contact edges of the first and second risers respectively, where the first and second contact edges are nearer the second ends of the respective first and second containers than a center of mass of each of the first and second containers. In certain examples, the distance between the second end of the first container and the second end of the second container is greater than the distance between the first contact edge of the first riser and the second contact edge of the second riser. In certain examples, the first and second containers each further comprise a second lift member, wherein the first and second lift members are positioned on opposite first and second sides of the respective first and second containers. In certain examples, the lift members are positioned nearer to the first end than to the second end of each of the first and second containers.

In one example, a method of emptying scrap from a laser cutting machine includes lifting a collection bin with a lifting assembly and a lifting device, moving the collection bin to a collection area, lowering the collection bin onto the first and second risers at first and second contact edges of a scrap bin, and emptying the scrap from the collection bin to the scrap bin. Lifting the collection bin in a containing state when the collection bin contains scrap in an interior space of both a first and second container. Each of the first and second containers includes a base; opposite first and second sidewalls; an end wall; a first lift member; and a first pivot member. The opposite first and second sidewalls extend from the base and between a first end and second end; the end wall extends from the base and between the first and second sidewalls at the second end. The first lift member is positioned between the first and second ends such that the lift member is nearer the first end than the second end. The first lift member is configured to facilitate movement of the collection bin. The interior space is defined by the base, the first and second sidewalls, and the end wall. The interior space is configured to hold material. The first pivot member extends between the first and second containers and is configured to facilitate a transition of the collection bin between a containing state and an emptying state. The collection area includes the scrap bin with first and second risers positioned on top ends of opposite sides of the scrap bin. The first and second contact edges are positioned nearer to the corresponding second end of the first and second container than the center of mass of the each first and second container. The collection bin transitions from the containing state to the emptying state as the first ends of the first and second containers move below the contact edges and away from each other while the second ends remain above the contact edges such that the first and second containers pivot about locking member locations on the pivot member.

### BRIEF DESCRIPTION OF THE DRAWINGS

FIG. 1 is a perspective view of an example laser cutting machine in accordance with the principles of the present disclosure.

FIG. 2 is another perspective view of the laser cutting machine of FIG. 1 where example collection bins are showing.

FIG. 3 is a perspective view of an example collection bin in a containing state in accordance with the principles of the present disclosure.

FIG. 4 is a first side view of the collection bin shown in FIG. 3.

FIG. 5 is a first end view of the collection bin shown in FIG. 3.

FIG. 6 is a top view of the collection bin shown in FIG. 3.

FIG. 7 is a perspective view of the collection bin shown in FIG. 3 in an emptying state.

FIG. 8 is a first side view of the collection bin shown in FIG. 3 in an emptying state.

FIG. 9 is a perspective view of an example pivot member in accordance with the principles of the present disclosure.

FIG. 10 is a perspective view of an example lift assembly in accordance with the principles of the present disclosure.

FIG. 11 is a perspective view of the collection bin of FIG. 3 in use with the lift assembly of FIG. 10 and a lift device in accordance with the principles of the present disclosure.

FIG. 12 is a perspective view of the collection bin of FIG. 3 in a containing state contacting risers before emptying material into a scrap bin in accordance with the principles of the present disclosure.

FIG. 13 is a perspective view of the collection bin of FIG. 3 in an emptying state contacting risers and emptying material into a scrap bin in accordance with the principles of the present disclosure.

FIG. 14 is a perspective view of the collection bin of FIG. 3 in an emptying state contacting a scrap bin and emptying material into the scrap bin in accordance with the principles of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

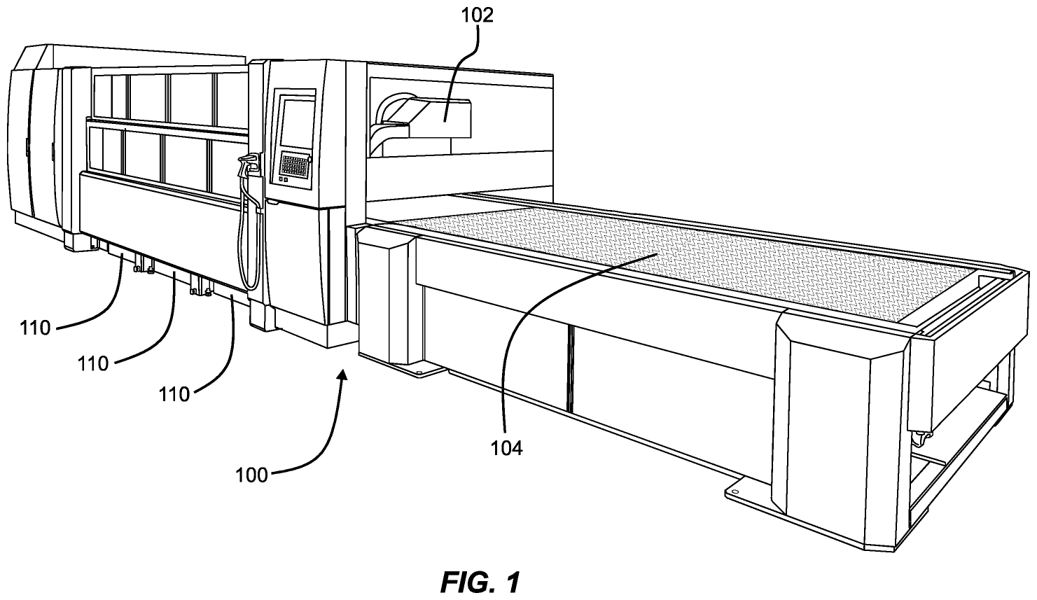

FIG. 1 shows the outside of a typical laser cutting machine 100. The example laser cutting machine 100 of FIG. 1 includes laser cutter 102, a work surface 104, and three collection bins 110 positioned below the laser cutter 102. The collection bins 110 collect scrap and other debris coming from the laser cutting process. It should be appreciated, however, that many different laser cutters 102 and laser cutting machines 100 exist and therefore designs of collection bins vary. The inventive aspects of the present disclosure may be adapted to suit any specific laser cutter 102 or laser cutting machine 100.

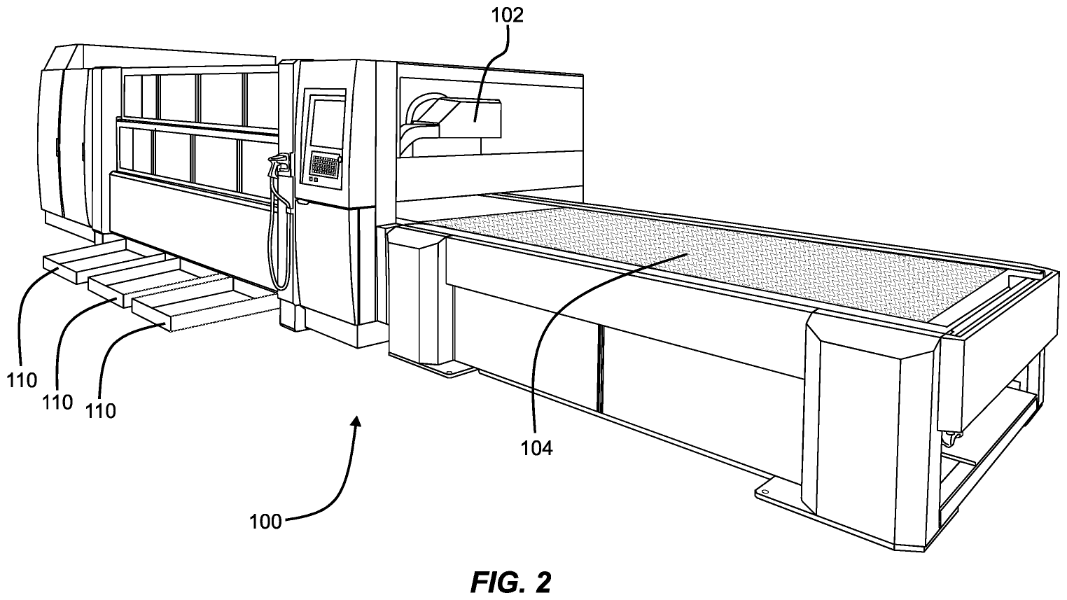

Scrap produced from the laser cutting machine 100 builds up in the collection bins 110 over time and periodically the collection bins 110 require emptying. FIG. 2 shows an example laser cutting machine 100 where the collection bins 110 slide out from under the laser cutter 102 such that the collection bins may be removed from the laser cutting machine for emptying. In some instances, the collection bins 110 may seat within existing bins below the laser cutting machine 100. In effect, collection bins 110 may be an additive feature to an existing laser cutting machines 100 such that no alterations are made to the laser cutting machine and the safety features of the laser cutting machine 100 are not altered.

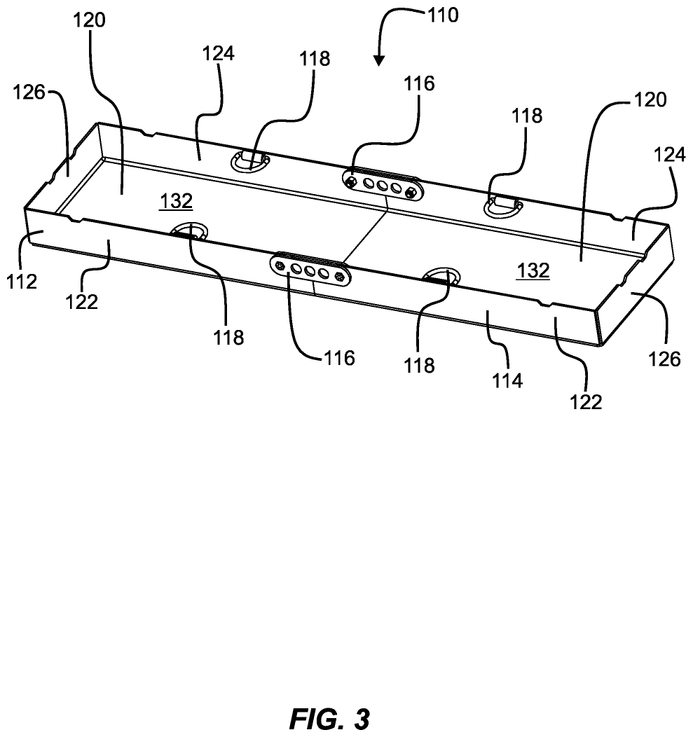

An example collection bin 110 shown in FIG. 3 includes a first container 112 and a second container 114. The first and second containers 112, 114 are linked by two pivot members 116. The first and second containers 112, 114 each include two lift members 118.

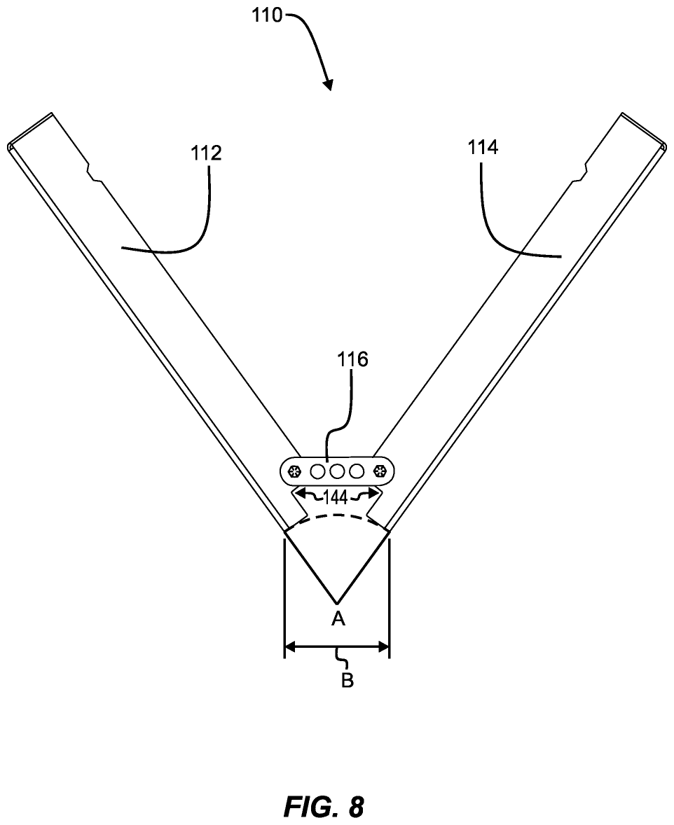

In this example, the first and second containers 112, 114 are the same build. Each of the first and second containers 112, 114 include a base 120, a first sidewall 122, a second sidewall 124, and an end wall 126. The base 120 extends from a first end 128 to a second end 130, a length L, and between the first and second sidewalls 122, 124, a width W. The first and second sidewalls extend between the first end 128 and second end 130. The end wall 126 extends between the first and second sidewalls 122, 124 at the second end 130. The first and second sidewalls 122, 124 and the end wall 126 extend outward from the base 120 to a height H to form an interior space 132. In the present example, the first and second sidewalls 122, 124 each include a relief 144 on the first end 128 (shown in FIG. 8). The relief 144 provides clearance for the pivot member 116. The relief 144 may vary in shape and size depending on the pivot member 116. In the present example, the relief 144 is an L-shaped cutout from each sidewall 122, 124 at a first end corner opposite the base 120.

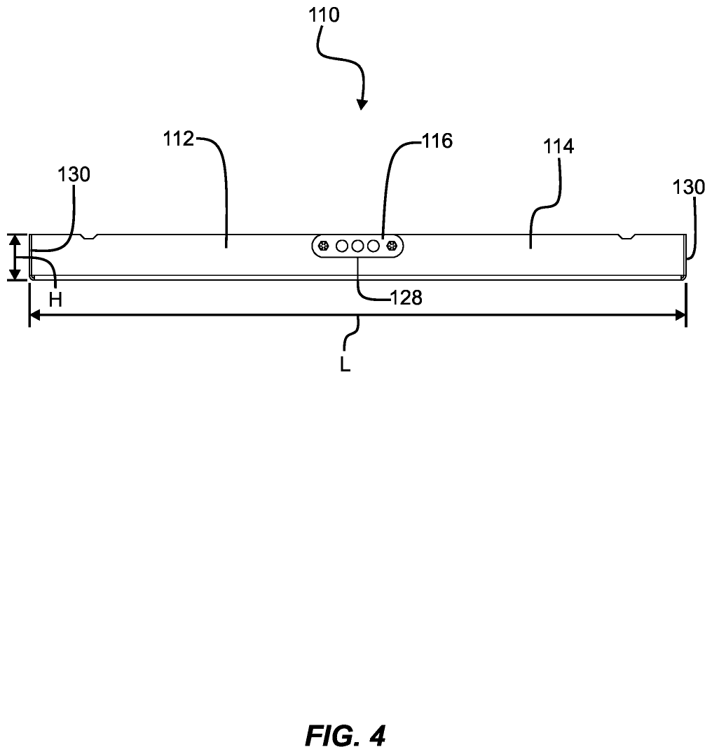

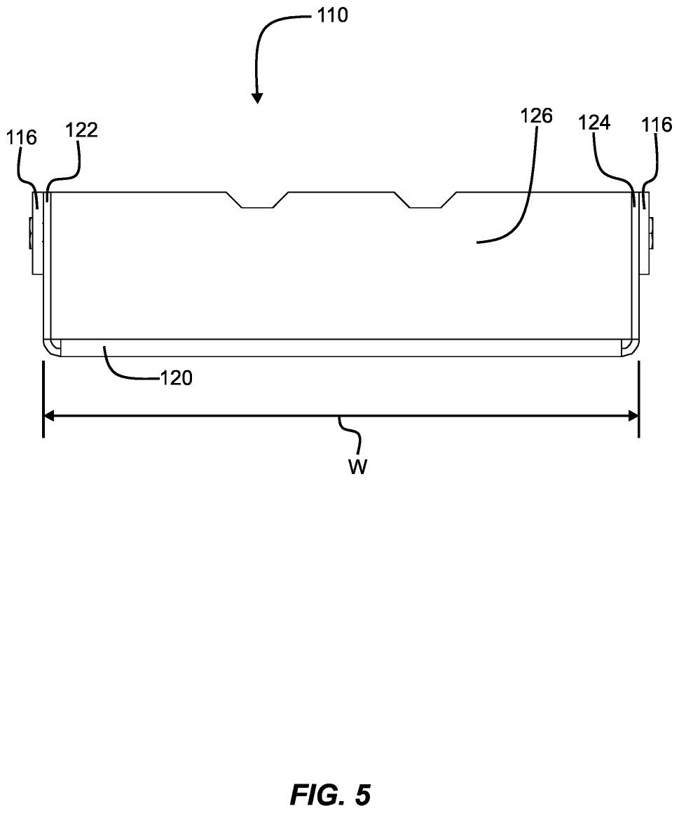

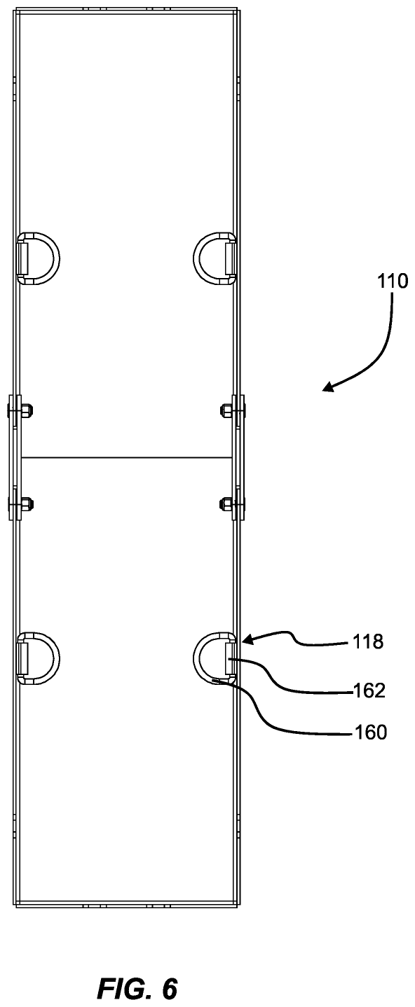

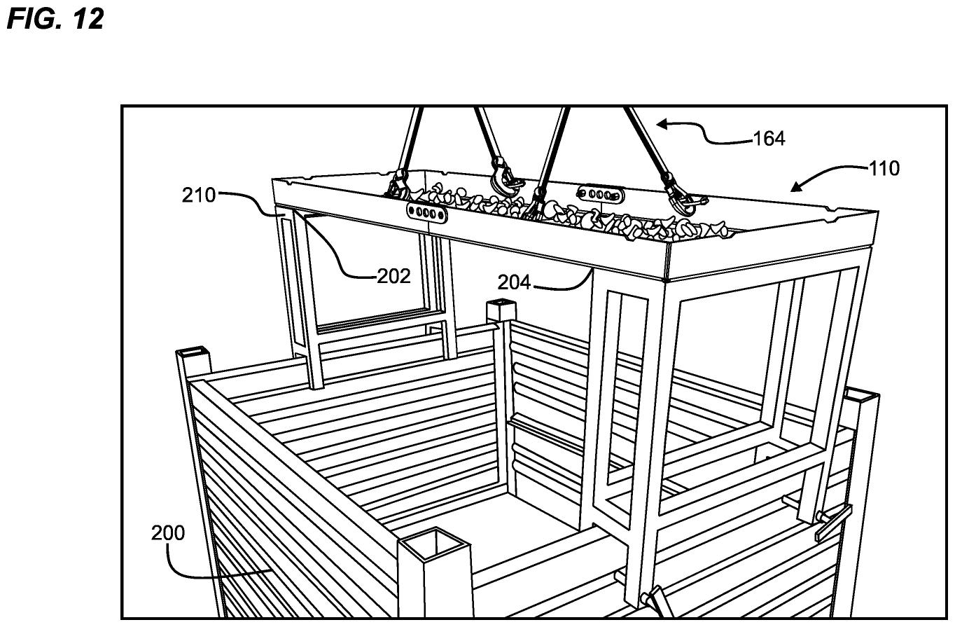

In the present example (FIGS. 3-8), the first and second containers 112, 114 are each made from a single piece of material that is bent or otherwise formed into the container shape. In this example, base 120 includes rounded edges as a result of bending the sidewalls 122, 124, and end wall 126. The seams between the sidewalls 122, 124 and the end wall 126 are welded together. In other examples, the base 120, first and second side walls 122, 124, and end wall 126 may be separate components held together any number of ways. For example, the parts may be held together by welding, adhering, fastening, bolting, etc. The dimensions (L×W×H) of each of the first and second containers may vary to accommodate numerous different laser cutting machine 100 designs, space constraints, and the size of scrap receptacles 200 (as shown in FIGS. 12-14) that may be used to collect scrap from the collection bins 110. In some examples, the length L is between 25 and 30 inches, the width W is between 12 and 20 inches, and the height H is between 3 and 5 inches.

The first and second containers 112, 114 may be made of various possible materials. Scrap from laser cutting often includes pieces of steel, aluminum, titanium, and other metals which can result in significant weights of scrap buildup in the collection bins 110. Occasionally, the laser cutter 102 can overshoot or spillover past the part and reach the collection bin 110. For these reasons, the collection bins 110 may preferably be made of steel. In one example, the first and second containers 112, 114 are made from 3/16 inch steel. In some examples, the steel may be thicker to accommodate higher power lasers.

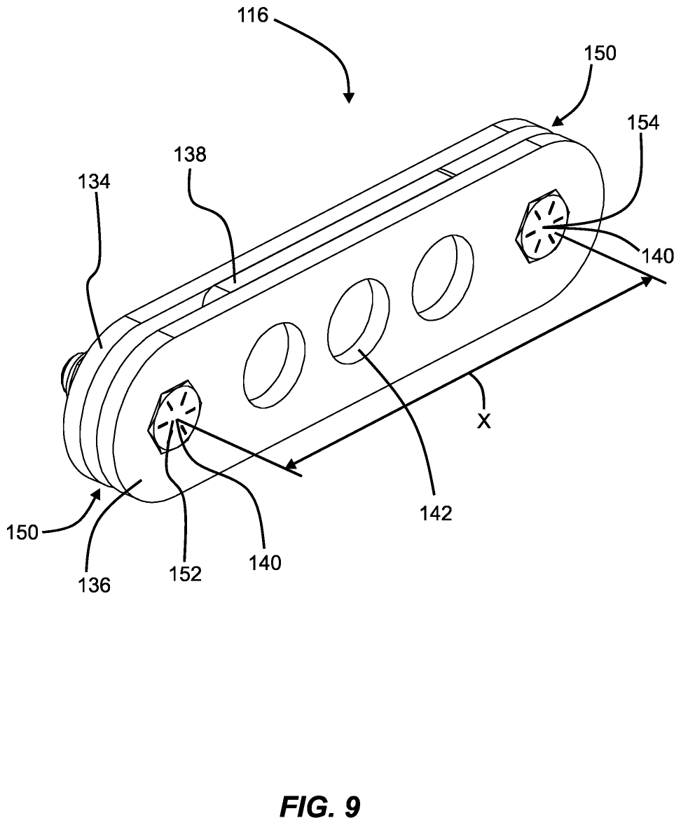

The pivot member 116 can take any form to accommodate the rotation of the of both the first and second containers 112, 114. In the example shown on FIG. 9, the pivot member 116 includes first and second outer plates 134, 136, a spacer 138, and two locking members 140.

In the present example, the first and second outer plates 134, 136 are functionally the same. The first and second outer plates have locking member locations 152, 154 that are separated by a length X. The length X correlates with how large an opening can form between the first and second containers 112, 114 when the first and second containers 112, 114 are in a separated, emptying state, at a maximum opening because the locking member locations 152, 154 are pivot axes for their associated container 112, 114. The locking member locations 152, 154 may be through holes to allow the locking members 140 to pass through. The first and second outer plates 134, 136 also include three apertures 142. The apertures 142 may be used to attach the spacer 138 to the first and second outer plates 134, 136. The apertures 142 may provide room to weld the spacer 138 to the first and second outer plates 134, 136.

In the present example, the spacer 138 separates the first and second outer plates 134, 136. The spacer 138 is sized smaller than the outer plates 134, 136. The spacer 138 is centered between the first and second outer plates such that a gap 150 between outer plates 134, 136 exists at each end of the spacer 138 with enough clearance for a portion of the sidewalls 122, 124 to fit within the gap 150 and for a locking member 140 to extend through the gap 150, thereby holding the pivot member to the container 112, 114. The thickness of spacer 138 determines the width of the gap 150 and corresponds to the thickness of the sidewalls 122, 124 such that the sidewalls 122, 124 are a close fit between inner sides of the outer plates 134, 136 within the gap 150. When the pivot member is connected to the first and second containers 112, 114, the spacer 138 occupies a majority of the space created by the reliefs 144 in both the first and second containers 112, 114.

In the present example, the locking members 140 are a nut and bolt combination where the head of the nut is recessed into the first outer plate and the shaft of the bolt travels through the locking member locations 152, 154 (152 of each first and second outer plates 134, 136 for the first container 112, and 154 of each first and second outer plates 134, 136 for the second container 114) and through a container aperture (not shown) located near the relief 144. The bolt is attached to an outer side of the second outer plate, which thereby attaches the container to the pivot member. The nut and bolt combination is tightened only enough to securely hold the containers 112, 114 and pivot member together, but not so tight as to prevent rotation of the containers 112, 114 about the shaft of the bolt.

In certain examples, a single pivot member 116 may be used. For example, a pivot member may attach to the bases 120 of the first and second containers 112, 114. In certain examples, the pivot member is a hinge. In certain examples, the pivot member may be an elastic member between first and second containers 112, 114.

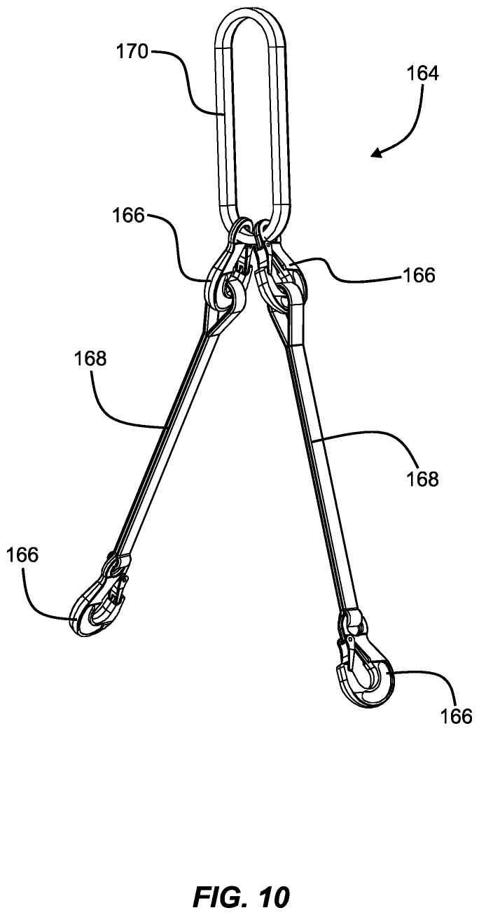

The lift members 118 facilitate movement of the collection bins 110 by providing linkage to lifting devices or lifting intermediaries. In the example shown in FIG. 1, the lift members 118 are positioned at intermediate locations between the first and second ends 128, 130 of each container 112, 114 and are attached to each of the sidewalls 122, 124. In other examples, the lift members may attach to the base centered about the width W such that only a single lift member 118 would be needed on each container 112, 114. In order to facilitate lifting of the collection bin 110, the lift members are positioned nearer the first 128 end than the second end 130 of each container 112, 114. Depending on the distribution of scrap on the collection bin 110, the desired lift member position may change. Where the distribution of weight is even across the area of base 120, the lift member must be positioned between the first end and half the length L toward the second end 130. Otherwise, the first and second containers 112, 114 would begin to rotate about the locking member locations 152, 154 and separate. In examples where the distribution of weight in the collection bin is uneven, the lift member position would need to adjust. In certain examples, the lift members 118 are positioned on the sidewalls 122, 124 between one quarter and one third of the length L from the first end 128. In other examples, the lift members 118 are positioned on the sidewalls 122, 124 between one third and one half of the length L from the first end 128. In other examples, the lift members 118 are positioned on the sidewalls 122, 124 at one third of the length L from the first end 128. In the present example, the lift member 118 is a ring 160 in a sleeve 162 where the sleeve is fixed to the collection bin. The sleeve 162 may be welded to the sidewalls 122, 124. In certain examples, the lift members 118 connect to a lift assembly 164 (as shown in FIG. 10).

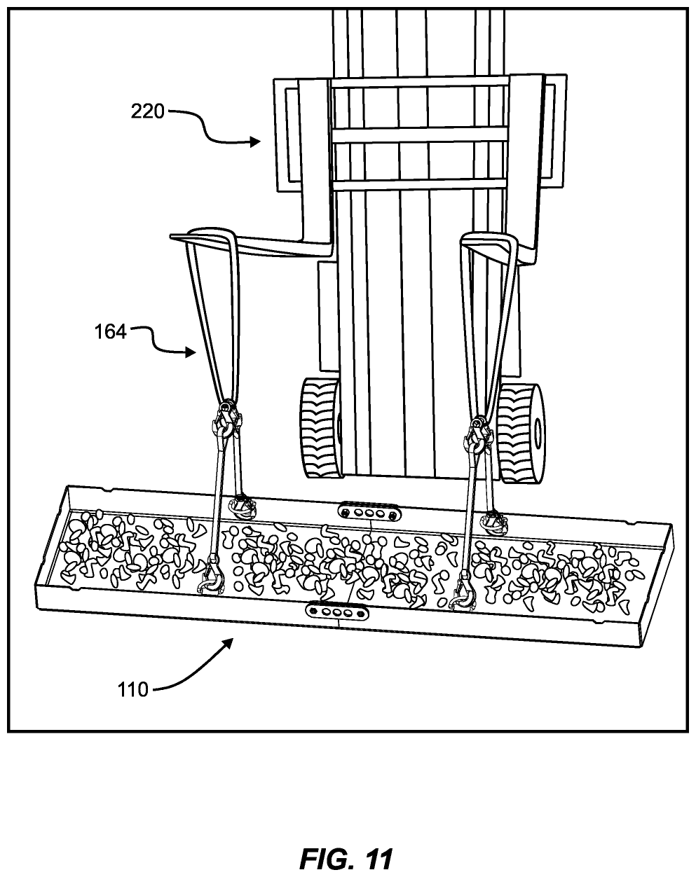

The lift assembly 164 may include any number of components needed to link to the collection bin 110 and a corresponding lifting device, such as a forklift. In the example shown in FIG. 10, the lift assembly includes four carabiners 166, two straps 168, and a shackle 170 for connecting the lift members on first and second sidewalls. The two carabiners also attach to straps which lead to the shackle. Two of the carabiners 166 link the straps to the lift members on the first and second sidewalls of a single container 112, 114. In the example shown in FIGS. 11-14, two lift assemblies are used to attach the four lift members (two on each container 112, 114). In other examples, a single lift assembly 164 may be used, such as where only a single lift member 118 for each container 112, 114 is used.

In use, the collection bin 110 is positioned beneath the laser cutter 102 in a containing state and fills with various scrap, such as slugs and slag from the laser cutting process. The containing state occurs when the first ends 128 of each container 112, 114 are nearest each other. While there may be a small gap as a result of variation, the two first ends 128 should touch or nearly touch in the containing state. Examples of the collection bin 110 in the containing state are shown in FIGS. 3, 4, 11, and 12. There may be any number of collection bins 110 positioned below the laser cutter 102. In certain examples, multiple collection bins 110 may be placed side by side within a single sliding bin to accommodate situations where the laser cutting machine 100 is placed near a wall such that clearance for sliding collection bins 110 out from under the laser cutter 102 is limited. Once the collection bin 110 is full, or during regular maintenance, the collection bin 110 is pulled or slid out from under the laser cutter 102. In certain examples, the collection bin 110 fits within sliding tracks, sliding bins, or other mechanisms that facilitate movement of the collection bin 110. In certain examples, the collection bin 110 may be an insert into an existing bin used on a given laser cutting machine 100.

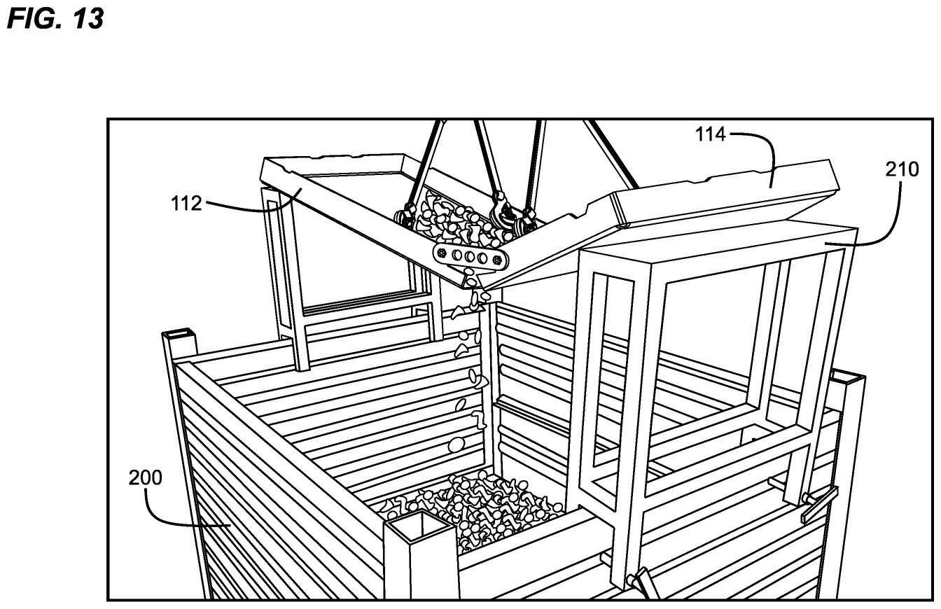

When the collection bin 110 is clear from under the laser cutter 102, one or more lift assemblies 164 are used to connect the lift members 118 of each container 112, 114. Depending on the position of the lift members 118, the distribution of scrap material may need to be adjusted. Once the lift assemblies are attached to both the collection bin 110 and the lifting device 220, the collection bin 110 is lifted and moved to a larger waste container, such as the scrap bin 200 shown in FIGS. 12-14. The collection bin 110 remains in the containing state while being lifted and moved. The collection bin 110 is then lowered onto either the sides of the scrap bin 200, or risers 210 (shown in FIGS. 12-13).

Contact between the container 112, 114 and the scrap bin 200 or riser 210 occurs at a bottom side of the base 120, usually between the lift member 118 and the second end 130. The edge where the first container 112 contacts the riser 210 or scrap bin 200 is the first contact edge 202 and the edge where the second container 114 contacts the riser 210 or scrap bin 200 is the second contact edge 204. Contact may occur anywhere along the bottom side of the base where the center of mass of the weighted container 112, 114 is nearer the first end 128 than the contact edges 202, 204 of the scrap bin 200 or riser 210. As the collection bin 110 is lowered onto a scrap bin 200 or riser 210 and weight due to gravity is applied, the collection bin 110 begins to open to an emptying state from the containing state as the second ends 130 are prevented from lowering by the contact edges 202, 204 of the scrap bin 200 or riser 210. The first ends 128 of each container 112, 114 continue downward and the pivot members 116 facilitate pivoting of each container 112, 114 about the respective locking member locations 152, 154. Comparing FIG. 12 with FIG. 13, the transition between the containing state (FIG. 12) and the emptying state (FIG. 13) can be seen.

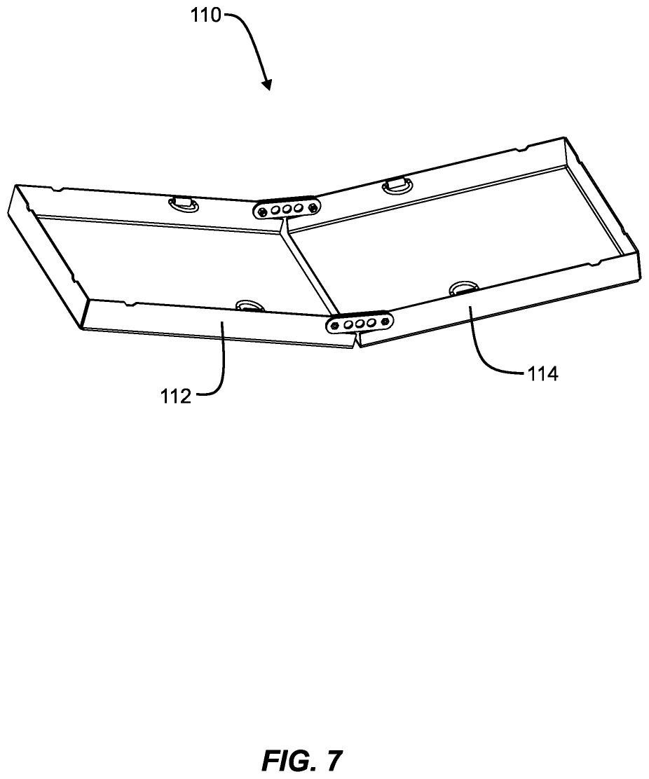

When the collection bin is in an emptying state, as shown in FIGS. 7, 8, 13, and 14, a space B forms between the first end 128 of the first container 112 and the first end 128 of the second container 114. The distance between first ends 128 of the containers 112, 114 changes as angle A (shown in FIG. 8) between the containers 112, 114 changes. The measured distance between first ends 128 (space B) is a function of angle A between the containers 112, 114, and the distance X between the locking member locations 152, 154. In the containing state, angle A is approximately 180 degrees and space B is near zero inches. As the collection bin 110 moves to the emptying state, angle A decreases and space B increases. There is also a critical angle A needed to enable sliding of scrap downward and out of the collection bin 110. The critical angle A is the angle at which scrap first begins sliding downward and out through space B. The critical angle A relates to the coefficient of static friction of the specific scrap material in the collection bin 110 and the coefficient of static friction of the base 120 of the collection bin 110.

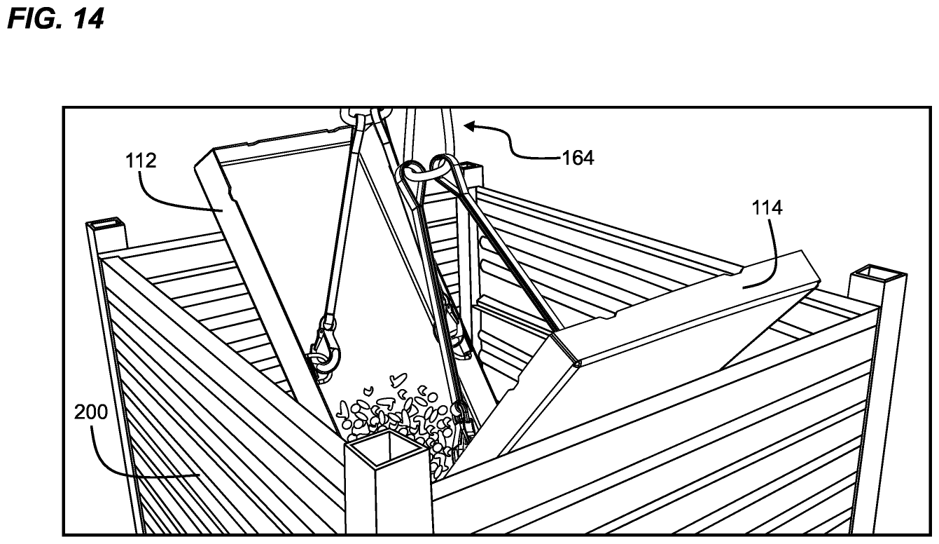

During normal emptying, the collection bin 110 opens well past the critical angle A of metal scrap in a steel collection bin 110 but the minimum achievable angle A (maximum space B) is dependent on the excess length of the collection bin (˜2 L) over the distance between the contact edges 202, 204 on the scrap bin 200 or risers 210. As the collection bin 110 is set onto the risers 210 or edges of the scrap bin 200, the collection bin 110 will open to the emptying state. If the collection bin 110 is allowed to continue moving downward, the angle A will decrease and the space B will increase until the second ends 130 of the containers 112, 114 reach the respective contact edges 202, 204. Where a scrap bin 200 is nearly full, scrap already in the scrap bin 200 may prevent full opening of the collection bin 110. For that reason, risers 210 may be useful. Risers 210 enable the collection bin 110 to begin emptying at a point higher above the scrap bin 200 below, and thus the scrap already in the scrap bin 200 does not interfere with opening. As can be seen in FIG. 14, the collection bin can open into the scrap bin 200 and occupy a significant amount of space. Risers may also include riser arms (not shown) that move the contact edge inward toward the first edges 128. The riser arms have the effect of increasing the maximum space B that can be achieved during emptying, but the riser arms also shift the center of mass location needed for the collection bin 110 to begin opening.

The collection bin 110 does not need to open to anything past the critical angle A in order to empty the scrap. Emptying will be slower when the collection bin 110 is near the critical angle A as compared to when the angle A is much smaller and the space B is larger. When the collection bin 110 is lifted upward from the scrap bin 200 or riser 210, the angle A increases and space B decreases until the collection bin 110 is returned to the containing state. Emptying the scrap from the collection bin 110 to the scrap bin 200 involves the collection bin 110 transitioning from the containing state to the emptying state as the first ends 128 of the first and second container 112, 114 move below the contact edges 202, 204 and away from each other while the second ends 130 remain above the contact edges 202, 204 such that the first and second containers 112, 114 pivot about locking member locations 152, 154 on the pivot member 116.

In some examples, a collection bin system may be sold as a kit. A collection bin system may include a collection bin 110, one or more lift assemblies 164, and two or more risers 210.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A collection bin for a laser cutting machine comprising:
a first container and a second container, each of the first and second containers comprising:
a base;
opposite first and second sidewalls extending from the base and between a first end and second end;
an end wall extending from the base and between the first and second sidewalls at the second end;
a first lift member positioned between the first and second ends such that the lift member is nearer the first end than the second end, the first lift member configured to facilitate movement of the collection bin;
an interior space defined by the base, the first and second sidewalls, and the end wall, the interior space configured to hold material; and
a first pivot member extending between the first and second containers and configured to facilitate a transition of the collection bin between a containing state and an emptying state.

2. The collection bin of claim 1, wherein the first and second containers each further comprise a second lift member, wherein the first and second lift members are positioned on opposite first and second sides of the respective first and second containers.

3. The collection bin of claim 1, wherein the collection bin further comprises a second pivot member, the second pivot member extending between the first and second containers and configured to facilitate movement of the collection bin between a containing state and an emptying state, wherein the first and second pivot members are positioned on opposite first and second sides of the collection bin.

4. The collection bin of claim 3, wherein the first ends of the first and second containers are in contact and the bases of the first and second containers are in plane with each other when the collection bin is in the containing state.

5. The collection bin of claim 3, wherein the first ends of the first and second containers are apart and the bases of the first and second containers are at an angle to each other when the collection bin is in the emptying state.

6. The collection bin of claim 2, wherein the first lift member is at the first sidewall and the second lifting member is at the second sidewall.

7. The collection bin of claim 3, wherein the first pivot member connects to the first sidewall of both the first and second containers at first and second locking member locations, and the second pivot member connects to the second sidewall of both the first and second containers at first and second locking member locations.

8. The collection bin of claim 7, wherein the first sidewall includes a container aperture configured to engage the first pivot member, and wherein the second sidewall includes a container aperture configured to engage the second pivot member.

9. The collection bin of claim 8, wherein the first and second sidewalls each include a relief at the first end to provide clearance for the first and second pivot members.

10. The collection bin of claim 2, wherein the lift members are positioned nearer to the first end than to the second end of each of the first and second containers.

11. The collection bin of claim 5, wherein the collection bin is configured to transition into the emptying state when a bottom side of the base of each first and second containers contacts first and second contact edges of a scrap bin respectively, wherein the first and second contact edges are nearer the second ends of the respective first and second containers than a center of mass of each of the first and second containers.

12. The collection bin of claim 2, wherein the first and second lift member of each of the first and second containers are configured to connect to a lift assembly.

13. A collection bin system for a laser cutting machine comprising:
a collection bin comprising:
a first container and a second container, each of the first and second containers including:
a base;
opposite first and second sidewalls extending from the base and between a first end and a second end;
an end wall extending from the base and between the first and second sidewalls at the second end;
a first lift member positioned between the first and second ends such that the first lift member is nearer the first end than the second end;
an interior space defined by the base, the first and second sidewalls, and the end wall, the interior space configured to hold material; and
a first pivot member extending between the first and second containers and configured to facilitate a transition of the collection bin between a containing state and an emptying state;
a lift assembly removably attached to the first lift member and configured to facilitate movement of the collection bin; and
first and second risers configured to be positioned at a material collection area and to provide clearance for the collection bin to transition from the containing state to the emptying state when the collection bin is positioned at first and second contact edges on the respective first and second risers.

14. The collection bin of claim 13 wherein the first ends of the first and second containers are in contact and the bases of the first and second containers are in plane with each other when the collection bin is in the containing state.

15. The collection bin of claim 13, wherein the first ends of the first and second containers are apart and the bases of the first and second containers are at an angle to each other when the collection bin is in the emptying state.

16. The collection bin system of claim 15, wherein the collection bin is configured to transition into the emptying state when a bottom side of the base of each first and second containers contacts first and second contact edges of the first and second risers respectively, wherein the first and second contact edges are nearer the second ends of the respective first and second containers than a center of mass of each of the first and second containers.

17. The collection bin system of claim 13, wherein the distance between the second end of the first container and the second end of the second container is greater than the distance between the first contact edge of the first riser and the second contact edge of the second riser.

18. The collection bin of claim 13, wherein the first and second containers each further comprise a second lift member, wherein the first and second lift members are positioned on opposite first and second sides of the respective first and second containers.

19. The collection bin of claim 18, wherein the lift members are positioned nearer to the first end than to the second end of each of the first and second containers.

20. A method of emptying scrap from a laser cutting machine comprising:
lifting a collection bin with a lifting assembly and a lifting device, the collection bin in a containing state and containing scrap in an interior space of both a first and second container, each first and second container including:
a base;
opposite first and second sidewalls extending from the base and between a first end and a second end;
an end wall extending from the base and between the first and second sidewalls at the second end;
a first lift member positioned between the first and second ends such that the first lift member is nearer the first end than the second end;
an interior space defined by the base, the first and second sidewalls, and the end wall, the interior space configured to hold material; and
a first pivot member extending between the first and second containers and configured to facilitate a transition of the collection bin between the containing state and an emptying state;
moving the collection bin to a collection area, the collection area including a scrap bin with first and second risers positioned on top ends of opposite sides of the scrap bin;
lowering the collection bin onto the first and second risers at first and second contact edges, the first and second contact edges positioned nearer to the corresponding second end of the first and second container than the center of mass of the each first and second container; and
emptying the scrap from the collection bin to the scrap bin, the collection bin transitioning from the containing state to the emptying state as the first ends of the first and second containers move below the contact edges and away from each other while the second ends remain above the contact edges such that the first and second containers pivot about locking member locations on the pivot member.
